(19) United States
(12) Patent Application Publication
(10) Pub. No.: US 2010/0027150 A1
(43) Pub. Date: Feb. 4, 2010

(54) MAGNETIC STORAGE APPARATUS AND METHOD FOR TESTING THEREOF

(75) Inventor: Ippei Deguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/488,115

(22) Filed: Jun. 19, 2009

(30) Foreign Application Priority Data
Jul. 30, 2008 (JP) 2008-195685

(51) Int. Cl. G11B 27/36; G11B 21/02

(52) U.S. Cl. 360/31; 360/75; G9B/27.052

(57) ABSTRACT

According to an aspect of the embodiment, a MCU divides a target track into recording areas on magnetic disks, assigns the recording areas to the magnetic heads, and performs write control during one rotation of the magnetic disks so that the magnetic heads write data in the recording areas assigned to the respective magnetic heads. After data writes by the magnetic heads, the MCU verifies whether data in the testing areas of the tracks adjacent to the target track is held without being erased.

### CROSS-REFERENCE TO RELATED APPLICATIONS

This application is based upon and claims the benefit of priority of the prior Japanese Patent Application No. 2008-195685, filed on Jul. 30, 2008, the entire contents of which are incorporated herein by reference.

### FIELD

The embodiments discussed herein are related to a magnetic storage apparatus and a method for testing thereof.

### BACKGROUND

Presently, a magnetic storage apparatus such as magnetic disk device increases in its storage capacity or its packaging density. Thus, it becomes important for reliability to conduct a side erase test. Side erase is a phenomenon in which, when data is written continuously in a specific track (target track) of a magnetic storage medium such as a magnetic disk, data is erased which is previously written on tracks adjacent to the specific track. The side erase test involves writing data a plurality of times, for example, a million times, in the specific track of a magnetic storage medium, and verifying whether data on tracks adjacent to the specific track can be read without being erased.

In the above side erase test of the magnetic disk device, data is written in a plurality of disks as follows. Specifically, in the above method, one magnetic head (HD) writes data in an entire area of a specific track during one rotation of a magnetic disk. And, after the one magnetic head finished to write data in the magnetic disk, another magnetic head writes data in an entire area of another specific track on a next magnetic disk. That is, each magnetic head writes successively data in an area corresponding to one rotation of one track, for example, one area illustrated in FIG. 9 which is located between one Index and the other Index.

To decrease the side erase, it is important to set optimum write current for a data write. The side erase test is conducted for each of a plurality of values of write current on each of all pairs of the magnetic head and the magnetic disk. And, an optimum write current for each of the all pairs is determined based on results of all the side erase tests. That is, after one side erase test is conducted by setting one of a plurality of values of write current, another side erase test is conducted by setting another of the plurality of values of write current.

A head-selection inspection method is proposed which writes data by selecting a plurality of magnetic heads in order, erases the written data by selecting one of the magnetic heads, reads the written data by selecting the magnetic heads in order, and determines that head selection is error when a disk surface without data is detected two or more times (see, for example, Japanese Patent Laid-Open No. 8-138219).

### SUMMARY

According to an aspect of the embodiment, a method for testing a magnetic storage apparatus is disclosed which has a plurality of magnetic storage media each including a target track and tracks adjacent to the target track, and a plurality of magnetic heads each corresponding to different one of the plurality of magnetic storage media. The method includes a control step of dividing a target track into a plurality of recording areas on the respective magnetic storage media, assigning each of the plurality of recording areas to each of the plurality of magnetic heads, and writing data by each of the plurality of magnetic heads during one rotation of the magnetic storage media in each of the plurality of recording areas assigned to each of the plurality of magnetic heads; and a verification step of verifying, after writing data by the magnetic heads, whether data of the tracks adjacent to the target track is held.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary structure of a magnetic storage apparatus according to an embodiment;

FIG. 2 is a diagram illustrating how recording areas are assigned to magnetic heads;

FIG. 3 is a diagram illustrating write operations by the magnetic heads in the recording areas assigned to the respective magnetic heads;

FIG. 4 is an exemplary flowchart of a side erase test;

FIG. 5 is a diagram illustrating an example in which an optimum value of write current is determined;

FIG. 6 is an exemplary flowchart illustrating the process of determining an optimum value of write current;

FIG. 7 is another exemplary flowchart illustrating the process of determining an optimum value of write current;

FIG. 8 is a diagram illustrating an application example of the test method for the magnetic storage apparatus in the present embodiment; and

FIG. 9 is a diagram illustrating an area corresponding to one rotation of a track.

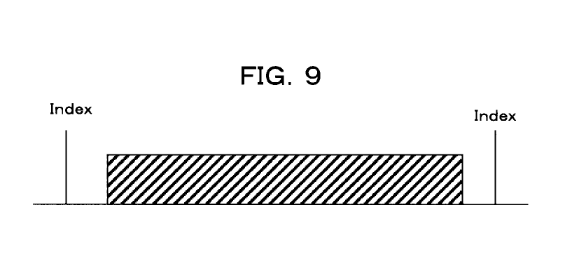

### DESCRIPTION OF EMBODIMENTS

We studied the above side erase test for a magnetic disk device (hereinafter, referred to “studied side erase test”). In the studied side erase test, data is written in an area corresponding to one rotation of a track using each magnetic head successively. Accordingly, test time increases in proportion to the number of heads mounted on the magnetic disk device. For example, a magnetic recording apparatus is considered in which has a rotational speed of the magnetic disk is 15000 rpm (revolutions per minute), eight magnetic heads are provided, and takes 1.5 hours to write data in an area corresponding to one rotation of a track one million times using one magnetic head. In this case, by the above side erase test, data write time in a single side erase test is 12 hours, which is equal to 1.5 hours multiplied by 8. Also, for example, when the rotational speed of the magnetic disk is 4200 rpm and it takes 3.5 hours to write data in an area corresponding to one rotation of a track using one magnetic head, by the above side erase test, data write time in a single side erase test is 28 hours, which is equal to 3.5 hours multiplied by 8.

Also, in the studied side erase test technique, the side erase test is conducted for each of the plurality of values of write current, and determines an optimum write current based on results of all of the side erase tests. Thus, a time required to determine the optimum write current increases in proportion to the number of the values of write current.

A method for testing a magnetic storage apparatus disclosed bellow can conduct a side erase test of the magnetic storage apparatus in a short period of time.

A magnetic storage apparatus disclosed bellow can conduct a side erase test of the magnetic storage apparatus in a short period of time.

Preferred embodiments of the present invention will be explained with reference to accompanying drawings.

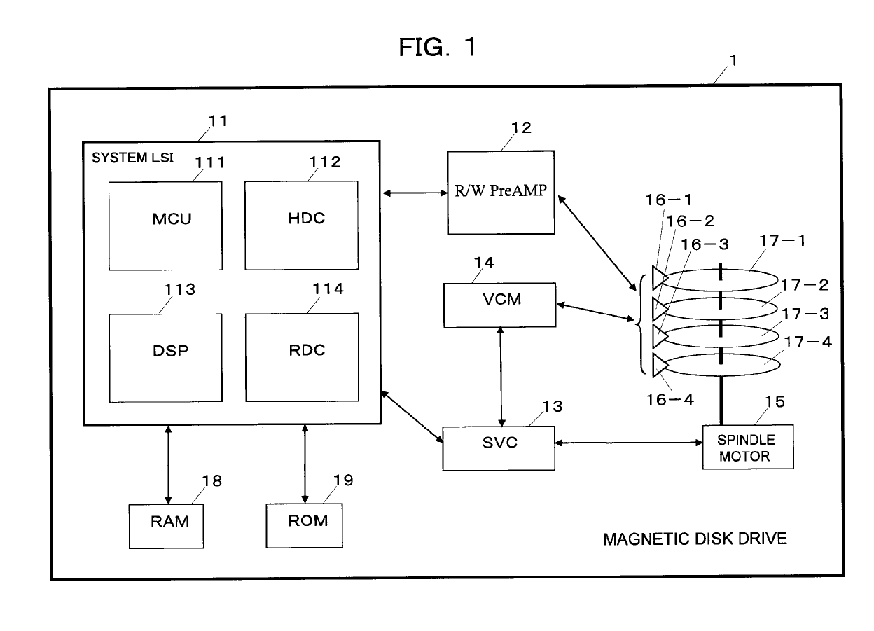

FIG. 1 is a diagram illustrating an exemplary structure of a magnetic storage apparatus according to an embodiment. In FIG. 1, a magnetic disk device 1 is explained as an example of the magnetic storage apparatus in the present embodiment. The magnetic disk device 1 writes data in and reads data from a plurality of magnetic disks 17 (magnetic disks 17-1 to 17-4). In particular, the magnetic disk device 1 in the present embodiment performs a side erase test. The side erase test is used for verifying whether or not, in the magnetic disks 17, data on tracks adjacent to a target track is held or recorded as it is written without being erased. The target track is a track in which the data is written. The tracks adjacent to the target track are, for example, tracks positioned at both side of the target track, but not limited to. Also, the magnetic disk device 1 determines a value of write current. The value of write current determined is used as an actual write current, in other words, an optimum write current.

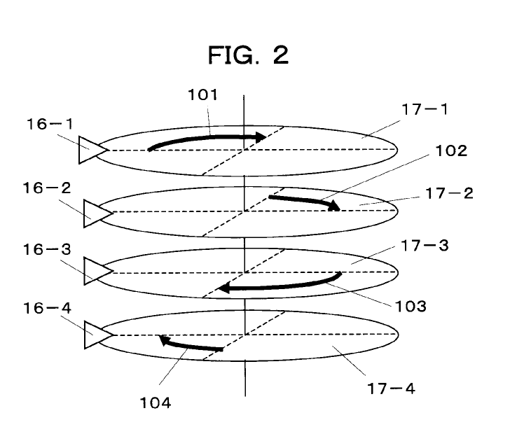

The magnetic disk device 1 includes a system LSI (Large Scale Integration) 11, a read and write preamplifier (R/W PreAMP) 12, a servo controller (SVC) 13, a voice coil motor (VCM) 14, a spindle motor (SP Motor) 15, a plurality of magnetic heads 16-1 to 16-4, a plurality of magnetic disks 17-1 to 17-4 mounted on the same axis, a RAM (Random Access Memory) 18, and a ROM (Read Only Memory) 19. In the present embodiment, each of the plurality of the magnetic heads 16 corresponds to a different or each of the plurality of the magnetic disks 17. That is, the magnetic heads 16-1, 16-2, 16-3, and 16-4 correspond to the magnetic disks 17-1, 17-2, 17-3, and 17-4, respectively, as illustrated in FIG. 2, which explains an example of a plurality of pairs of the magnetic head and the magnetic disk.

The system LSI 11 is an integration of core circuit blocks such as an MCU (Micro Computer Unit) 111, HDC (Hard Disk Controller) 112, DSP (Digital Signal Processor) 113, and RDC (Read Channel) 114 on a single LSI chip.

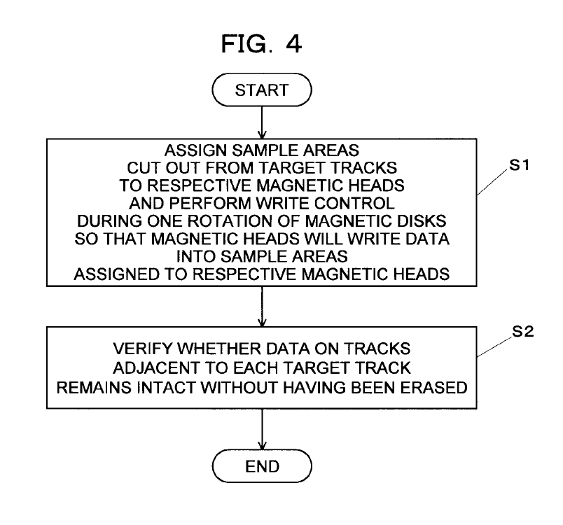

The MCU 111 reads an operating program for the magnetic disk device 1, controls various processing units of the magnetic disk device 1 according to the operating program. For example, the MCU 111 conducts side erase tests, and determines the value of write current, which is used as an optimum write current, for each of the plurality of pairs of the magnetic head and the magnetic disk. During the side erase test, the MCU 111 instructs the SVC 13 to position the magnetic heads 16 over the magnetic disks 17 corresponding thereto. Further, during the side erase test, the MCU 111 instructs the HDC 112 to write data in a predetermined track (target track) of the magnetic disks 17 a predetermined number of times through the magnetic heads 16 corresponding the magnetic disks 17. The target track and the number of times are defined in the instruction for the side erase test. The target track is a track in which a data is written for the side erase test, and is equal with one rotation of the magnetic disk 17. Single target track exists in one magnetic disk 17 at the same time. Prior to the side erase test, another predetermined data is written in the tracks adjacent to the target track. The tracks adjacent to the target track are to be tested in the side erase test. That is, as described later with reference to FIG. 4, the MCU 111 functions as a control unit. The control unit divides single target track, in other words, one rotation of the target track, into a plurality of recording area on single magnetic disk 17. The target track and the plurality of recording area may exist on both surface of the magnetic disk 17. The control unit assigns the recording areas to the respective magnetic heads 16, as illustrated in FIG. 2 described later. And, the control unit performs write control during one rotation of the magnetic disks 17 so that the magnetic heads 16 write data in the recording areas assigned to the respective magnetic heads 16.

After the data is written in the target track, the MCU 111 instructs the HDC 112 to read data from testing areas, and to verifies whether data in the testing area of the adjacent tracks is held without being erased based on results of the reads. The testing areas are areas to be tested, and exist on positions each of which is adjacent to the recording area assigned to the magnetic heads 16 in the tracks adjacent to the target track. More specifically, the MCU 111 measures an error rate of the read data from the testing areas, and determines whether the measured error rate exceeds a predetermined threshold. The threshold is defined empirically and in advance. When the error rate exceeds the threshold, the MCU 111 determines that the data in the testing area of the adjacent tracks is erased and cannot be read, or, that the side erase is occurred. When the error rate does not exceed the threshold, the MCU 111 determines that the data in the testing area of the adjacent tracks is not erased, or, that no side erase is occurred.

In addition, the MCU 111 determines the value of write current which is to be used as the optimum or actual write current. To this purpose, the MCU 111 divides a write time needed for each magnetic head 16 into a plurality of write time periods to write the data in the recording area, and sets different candidate values of write current for each divided write time periods, respectively. A plurality of candidate values of write current to be selected is determined in advance, and has a different value with each other. When the value of write current is large, error rate of data in the recording area is reduced, but side erase of data in the testing area is increased. When the value of write current is small, the error rate of data in the recording area is increased, but the side erase of data in the testing area is decreased. And, the MCU 111 performs write control to write the data during each of the divided write time periods using the respective candidate value of the write current by the magnetic head 16. Then, the MCU 111 verifies whether data in the testing areas of the tracks adjacent to the target track is held without being erased, and determines the value of write current, which is used as the optimum write current, based on results of the verification. In determining the value of write current, the MCU 111 may select the largest value from the candidate values at which data in the testing area of the adjacent tracks is held without being erased. Alternatively, the MCU 111 may measure error rates of data in the recording area of the target track in which the data is written using the respective candidate value of write current, and determine the value of write current which is used as the optimum write current based on results of the error rate measurement.

According to instructions from the MCU 111, the HDC 112 writes data in and reads data from the plurality of magnetic disks 17 through the plurality of magnetic heads 16, and sends the read data to the RDC 114. The RDC 114 converts the data read by the magnetic heads 16 from the magnetic disks 17 from analog signal to digital signal, and sends the digital signal to the DSP 113. The DSP 113 performs computations for servo processing, and sends the result of the computations to the SVC 13. The R/W PreAMP 12 performs signal conversion of read data read by the magnetic heads 16 and write data to be written in the magnetic disks 17 through the magnetic heads 16, to execute processing in the individual core blocks 111-114 of the system LSI 11. The SVC 13 controls the VCM 14 to position the magnetic heads 16. Also, the SVC 13 controls the SP Motor 15 to rotate the magnetic disks 17-1 to 17-4 simultaneously. According to instructions from the SVC 13, the VCM 14 positions the magnetic heads 16 by moving the magnetic heads 16 in a radial direction of the magnetic disks 17. The SP Motor 15 controls the rotation of the magnetic disks 17. The RAM 18 stores, for example, data to be written in the magnetic disks 17 and data read from the magnetic disks 17. The ROM 19 stores in advance the operating program for the magnetic disk device 1.

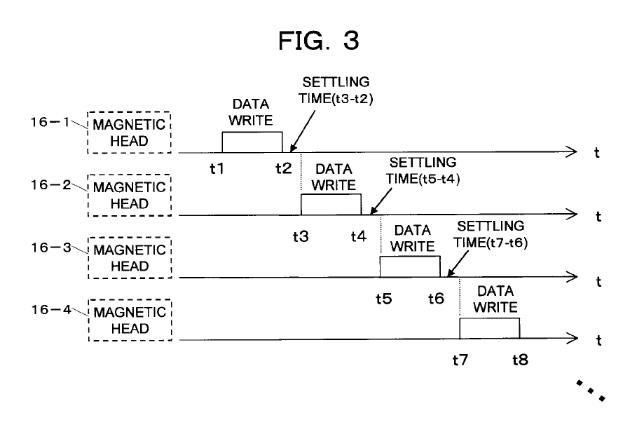

Write control performed by the MCU 111 is described with reference to FIGS. 2 and 3. FIG. 2 is a diagram illustrating how recording areas are assigned to the magnetic heads 16. In FIG. 2, recording areas 101 to 104 are assigned to the magnetic heads 16-1 to 16-4, are divided from the respective target track on the magnetic disks 17-1 to 17-4, and are written the data during the side erase test. Specifically, on the magnetic disks 17-1 to 17-4, the MCU 111 designate specific tracks each of which has same track number as the target track. By dividing the recording areas 101 to 104 from the respective target track, the MCU 111 assigns the recording area 101 on the magnetic disk 17-1 to the magnetic head 16-1, the recording area 102 on the magnetic disk 17-2 to the magnetic head 16-2, the recording area 103 on the magnetic disk 17-3 to the magnetic head 16-3, and the recording area 104 on the magnetic disk 17-4 to the magnetic head 16-4. As described above, the magnetic disks 17-1 to 17-4 rotate to same direction and with same speed with each other, and the magnetic heads 16-1 to 16-4 also move to same direction and with same speed with each other. However, the position is defined with only single pair of the magnetic head 16 and the magnetic disks 17 at same time. Thus, one rotation of the magnetic disk 17 or the one target track is divided into the same number with a number of the magnetic heads 16 which move at the same time. The number of the magnetic heads 16 which move at the same time is not limited to “four”. For example, each of the magnetic heads 16 writes the data on the same recording area in the corresponding target track one million times.

FIG. 3 is a diagram illustrating write operations by the magnetic heads in the recording areas assigned to the respective magnetic heads. Here, write operations are described by taking as an example the four magnetic heads 16 illustrated in FIG. 1. The MCU 111 rotates the magnetic disks 17-1 to 17-4 simultaneously. The MCU 111 selects the magnetic head 16-1, and positions the magnetic head 16-1 over the corresponding target track of the magnetic disk 17-1. And, MCU 111 writes data in the recording area 101 of FIG. 2 through the magnetic head 16-1 from time t1 to time t2. Next, during a predetermined settling time (t3−t2), the MCU 111 selects and positions the magnetic head 16-2 over the corresponding target track of the magnetic disk 17-2. The settling time is the time required for the MCU 111 to select and position a magnetic head 16 over the appropriate or corresponding target track. The settling time is for preparation of the magnetic heads 16 to write data in the corresponding magnetic disk 17, and is determined in advance. Once the magnetic head 16-2 is positioned, the MCU 111 writes data in the recording area 102 of FIG. 2 through the magnetic head 16-2 from time t3 to time t4.

Next, during a settling time (t5−t4), the MCU 111 selects and positions the magnetic head 16-3 over the corresponding target track of the magnetic disk 17-3. Once the magnetic head 16-3 is positioned, the MCU 111 writes data in the recording area 103 of FIG. 2 through the magnetic head 16-3 from time t5 to time t6. Next, during a settling time (t7−t6), the MCU 111 selects and positions the magnetic head 16-4 over the corresponding target track of the magnetic disk 17-4. Once the magnetic head 16-4 is positioned, the MCU 111 writes data in the recording area 104 of FIG. 2 through the magnetic head 16-4 from time t7 to time t8.

Subsequently, the MCU 111 selects the magnetic heads 16-1, 16-2, 16-3, and 16-4 in sequence, and writes data in the respective recording areas through the respective magnetic heads 16 in a similar manner a predetermined number of times (e.g., one million times). Then, if needed, the target track is changed, and the side erase test may executed on the newly selected target track in a similar manner.

FIG. 4 is an exemplary flowchart of a side erase test. The MCU 111 assigns recording areas divided from the target track on the magnetic disks 17 to the respective magnetic heads 16, and performs write control during one rotation of the magnetic disks 17. Thus, the magnetic heads 16-1 to 16-4 write data in the recording areas of the magnetic disks 17-1 to 17-4, which are assigned to the respective magnetic heads 16 (step S1). In the step S1, the MCU 111 determines recording areas to be assigned to the respective magnetic heads 16 based on the time required for the magnetic disks 17 to make one rotation, the number of sectors (recording areas in one rotation or one target track), a settling time, and the number of magnetic heads 16 per track, which are determined in advance. And then, by performing write control as described with reference to FIGS. 2 and 3, the MCU 111 writes data in the recording area one million times, for example. Next, after the data writes by the magnetic heads 16, the MCU 111 verifies whether data in the testing areas of the tracks adjacent to the target track is held without being erased (step S2). Specifically, the MCU 111 reads data in the testing areas of the tracks adjacent to the target track, to which the recording area assigned to the magnetic head 16. Then, the MCU 111 measures an error rate of the read data from the testing areas, and determines whether the measured error rate exceeds the predetermined threshold. When the error rate exceeds the threshold, the MCU 111 determines that the data in the testing area of the adjacent tracks is erased, and cannot be read correctly, in other words, that the side erase has occurred. When the error rate does not exceed the threshold, the MCU 111 determines that no side erase has occurred.

An advantage of the side erase test for the magnetic storage apparatus in the present embodiment is described with reference to FIG. 4. As described above, in the studied side erase test for a magnetic storage apparatus (magnetic disk device), the data writes data in an area which correspond with one rotation of one track using each magnetic head 16 successively. Further, in this case, it is supposed that rotational speed of the magnetic disks 17 is 15000 rpm, that there are four magnetic heads 16, and that it takes 1.5 hours to write data in an area corresponding to one rotation of a track one million times using one magnetic head 16. Then, data write time in a single side erase test is 6 hours. On the other hand, with the side erase test for the magnetic storage apparatus in the present embodiment described with reference to FIG. 4, data can be written in the target track of four magnetic disks 17 per one rotation of the SP Motor 15. Thus, data write time in a single side erase test is 1.5 hours (6 hours divided by 4). Accordingly, the present embodiment can greatly reduce the time required for the side erase test.

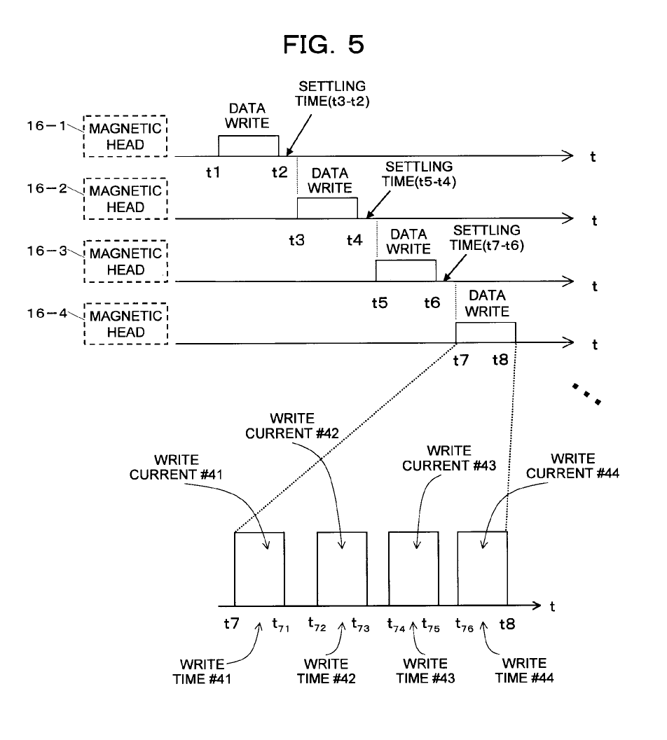

FIG. 5 is a diagram illustrating an example in which a value of write current which is used as the optimum write current is determined. The time period from time t1 to time t2 in FIG. 5 corresponds to data write time for a writing in the recording area 101 of FIG. 2 through the magnetic head 16-1. The time period from time t3 to time t4 corresponds to data write time for a writing in the recording area 102 of FIG. 2 through the magnetic head 16-2. The time period from time t5 to time t6 corresponds to data write time for a writing in the recording area 103 of FIG. 2 through the magnetic head 16-3. The time period from time t7 to time t8 corresponds to data write time for a writing in the recording area 104 of FIG. 2 through the magnetic head 16-4.

The MCU 111 divides the write time needed for each magnetic head 16 to write data in the recording area. Specifically, the MCU 111 determines recording areas for the respective magnetic heads 16, and divides the data write time used for the recording area in the same number with the predetermined number of write currents. For example, the MCU 111 divides the data write time (time period from time t7 to time t8 in FIG. 5) of the magnetic head 16-4 in segments, and sets write currents (write current #41 to write current #44) with different values for resulting divided write time periods, respectively. Specifically, as illustrated in FIG. 5, the MCU 111 sets write current #41 for the time period from time t7 to time t71 (write time #41), write current #42 for the time period from time t72 to time t73 (write time #42), write current #43 for the time period from time t74 to time t75 (write time #43), and write current #44 for the time period from time t76 to time t8 (write time #44).

Then, the MCU 111 performs control so that each magnetic head 16 writes data in the divided write time periods using the write current values set for the respective divided write time periods. For example, in the data write operations by the magnetic head 16-4, the MCU 111 controls the magnetic head 16-4 to write data using the write current #41 in the write time #41, to write data using the write current #42 in the write time #42, to write data using the write current #43 in the write time #43, and to write data using the write current #44 in the write time #44. Then, the MCU 111 verifies whether data in the testing area of the tracks adjacent to the target track is held without being erased, and determines the value of the write current which is used as the optimum write current based on results of the verification. For example, from the write current values at which data in the testing area of the adjacent tracks is held without being erased, the MCU 111 determines or selects the largest value as the optimum value of write current. For example, the MCU 111 reads the data from the testing areas in the tracks adjacent to the target track, measures error rates of the read data from the testing areas, and determines the candidate value of write current which gives the lowest measured error rate (in total) as the optimum value of write current. Alternatively, the MCU 111 may measure error rates of data in the recording area of the target track in which the data is written using the candidate values of write current, and may determine the candidate value of write current which gives the lowest measured error rate (in total) as the optimum value of write current.

Besides, the MCU 111 may determine the number of write current values based on the number of sectors needed to measure an error rate and the number of sectors contained in the recording area of the magnetic disks 17, so as to divide the data write time for the recording area by the number of the candidate values of write current.

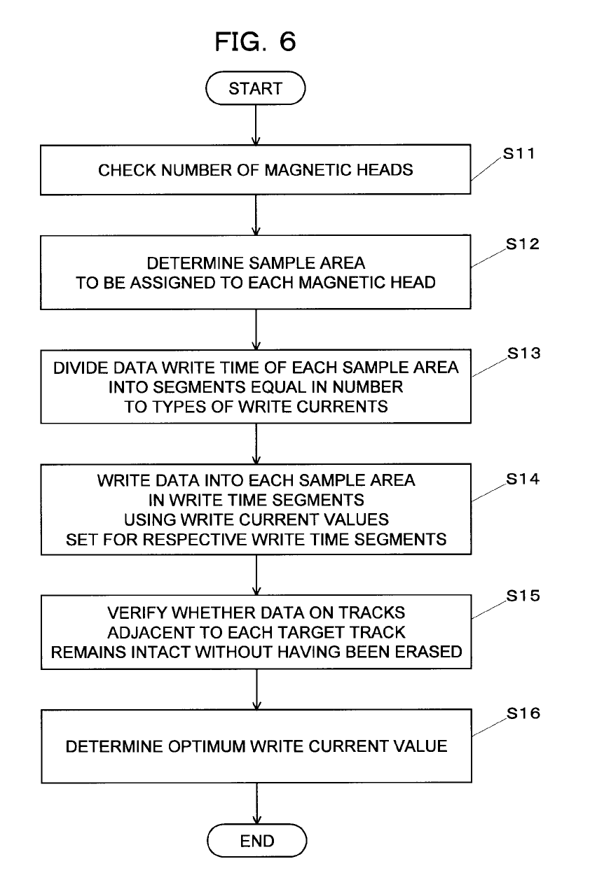

FIG. 6 is an exemplary flowchart illustrating the process of determining the value of write current which is used as the optimum write current. First, the MCU 111 checks the number of magnetic heads 16 (step S11). The MCU 111 determines a recording area to be assigned to each magnetic head 16 based on the number of magnetic heads 16 found by the check and on the time required for the magnetic disks 17 to make one rotation, the number of sectors per track, and a settling time, which are determined in advance (step S12). Next, the MCU 111 divides the data write time for the recording area into the number which are the same with the number of the candidate values of write current determined in advance (step S13). The MCU 111 controls to instruct each magnetic head 16 to write data in the appropriate or corresponding recording area during the divided write time periods, using the write current values set for the respective divided write time periods (step S14). Next, the MCU 111 verifies (determines) whether data in the testing areas of the tracks adjacent to the target track is held without being erased (step S15). From the write current values at which data in the testing area of the adjacent tracks is held without being erased, the MCU 111 determines or selects the largest candidate value of write current as the optimum value of write current (step S16).

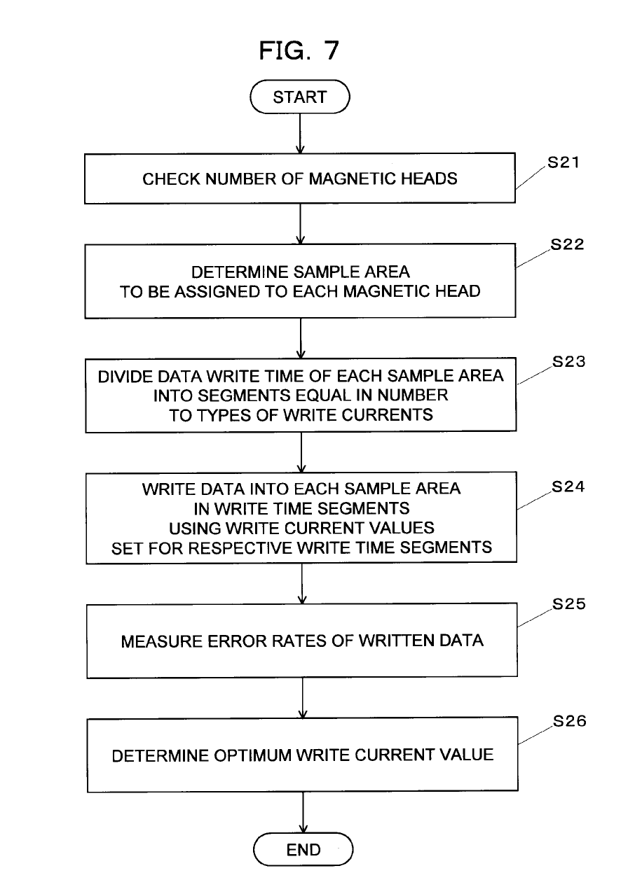

FIG. 7 is another exemplary flowchart illustrating the process of determining a value of write current which is used as the optimum write current. First, the MCU 111 checks the number of magnetic heads 16 (step S21). The MCU 111 determines a recording area to be assigned to each magnetic head 16 based on the number of magnetic heads 16 found by the check and on the time required for the magnetic disks 17 to make one rotation, the number of sectors per track, and a settling time, which are determined in advance (step S22). Next, the MCU 111 divides the data write time for the recording area into the same number with the number of the candidate number of write current determined in advance (step S23). The MCU 111 controls to instruct each magnetic head 16 to write data in the appropriate or corresponding recording area during the divided write time periods, using the write current values set for the respective divided write time periods (step S24). Next, when data writes in all the recording areas are finished, the MCU 111 measures error rates of the written data in the recording area in which the data is written using the candidate values of write current (step S25). Then, the MCU 111 determines the value of write current which gives the lowest measured error rate as the optimum value of write current (step S26).

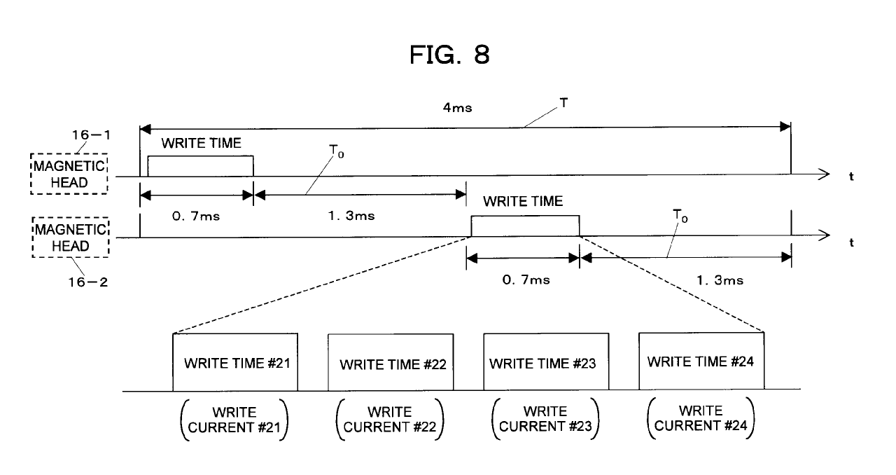

FIG. 8 is a diagram illustrating an application example of the test method for the magnetic storage apparatus in the present embodiment. For example, it is supposed that the time T required for the magnetic disks 17 to make one rotation is 4 ms, that the number of sectors (blocks) per track is 1200, that the settling time T0 is 1.3 ms, and that the number N of magnetic disks 17 is 2. The MCU 111 calculates the write time for each magnetic head 16 based on the time T required for the magnetic disks 17 to make one rotation, the settling time T0, and the number N of magnetic disks 17. The write time for each magnetic head 16 calculated is T/N−T0, which is 0.7 ms in this case. Also, the MCU 111 calculates the number of sectors (approximately 200 block) contained in the recording area assigned to each magnetic head 16 based on the number of sectors per track, the time T required for the magnetic disks 17 to make one rotation, and the write time for each magnetic head 16. Also, the MCU 111 sets four write currents based on the predetermined number of sectors (50 block) needed for measurement of an error rate, and the above-described number of sectors (approximately 200 block) contained in the recording area assigned to each magnetic head 16. For example, the MCU 111 sets four write currents, or, write current #21 to write current #24. Then, the MCU 111 divides the data write time for the recording area into the same number with the number of the determined write currents. For example, as illustrated in FIG. 8, the MCU 111 divides the write time of 0.7 ms in four segments, or write time #21 to write time #24.

The MCU 111 instructs the magnetic heads 16 to write data in the recording areas which have the number of sectors calculated above. Specifically, as illustrated in FIG. 8, the MCU 111 writes data for 0.7 ms using the magnetic head 16-1, and then switches from the magnetic head 16-1 to the magnetic head 16-2 during the settling time T0 of 1.3 ms. Then, the MCU 111 writes data for 0.7 ms using the magnetic head 16-2. The magnetic head 16-2 writes the data as follows (this is also applied to the magnetic head 16-1). Specifically, the magnetic head 16-2 writes data using the write current #21 during the write time #21, writes data using the write current #22 during the write time #22, writes data using the write current #23 during the write time #23, and writes data using the write current #24 during the write time #24, as illustrated in FIG. 7. When data writes in all the recording areas are finished, the MCU 111 measures error rates of the written data in the recording area in which the data is written. Then, the MCU 111 determines, for example, the write current #21 which gives the lowest measured error rate as the optimum value of write current.

An advantage of the test method for the magnetic storage apparatus in the present embodiment is described below. It is supposed, for example, that the rotational speed of the magnetic disks 17 is 15000 rpm, that there are four magnetic heads 16, and that four write currents are used. In the studied side erase test technique which writes data in an area corresponding with one rotation of a track using each magnetic head 16 successively, conducts a side erase test at each write current, and determines a value of write current based on results of all the side erase tests, it takes approximately 6 hours to conduct a side erase test, for example, and it takes 24 hours (approximately 6 hours multiplied by 4) to determine the value of write current which is used as the optimum write current.

On the other hand, with the test method for the magnetic storage apparatus in the present embodiment, the data can be written in a predetermined number of (e.g., four) magnetic disks 17 of the magnetic disk device 1 during one rotation of the SP Motor 15, using all the magnetic heads 16 in order. Thus, it is possible to make the time required to conduct the side erase test equal to the time required for the magnetic heads 16 to write data in the recording area in one rotation of a track in order divided by the number of magnetic disks 17 (approximately 1.5 hours in this example). Also, the test method for the magnetic storage apparatus in the present embodiment writes data with the magnetic heads 16 using all candidates for the value of write current, which is used as the optimum write current in a single side erase test. Thus, the value of write current which is used as the optimum write current can be determined based on results of the single side erase test. Thus, in this example, it takes approximately 1.5 hours to determine the value of write current, which is used as the optimum write current. In this way, the test method for the magnetic storage apparatus in the present embodiment can greatly reduce the time required to determine the value of write current, which is used as the optimum write current.

As described above, the magnetic storage apparatus and the method for testing thereof divide the target track into the plurality of recording areas on the magnetic storage media, assign the recording areas to the plurality of magnetic heads, and perform write control during one rotation of the magnetic storage media. And, the magnetic heads write data in the recording areas assigned to the respective magnetic heads. Thus, the magnetic storage apparatus and the test method thereof can reduce the data write time during the side erase test of the magnetic storage apparatus.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the sprit and scope of the invention.

What is claimed is:

1. A method for testing a magnetic storage apparatus having a plurality of magnetic storage media each including a target track and tracks adjacent to the target track and a plurality of magnetic heads each corresponding to different one of the plurality of magnetic storage media, the method comprising:
a control step of dividing a target track into a plurality of recording areas on the respective magnetic storage media, assigning each of the plurality of recording areas to each of the plurality of magnetic heads, and writing data by each of the plurality of magnetic heads during one rotation of the magnetic storage media in each of the plurality of recording areas assigned to each of the plurality of magnetic heads; and
a verification step of verifying, after writing data by the magnetic heads, whether data of the tracks adjacent to the target track is held.

2. The method for testing a magnetic storage apparatus according to claim 1,
wherein the control step divides a write time needed for each of the magnetic heads to write data in the recording area, sets different values of write current for the divided write time periods, and writes data by the magnetic heads in the divided write time periods using a plurality of candidate values of write current, and
wherein the verification step verifies whether data of the tracks adjacent to the target track is held, and determines a value of the write current used for writing data in the target track based on results of the verification.

3. The method for testing a magnetic storage apparatus according to claim 1,
wherein the control step divides a write time needed for each of the magnetic heads to write data in the recording area, sets different values of write current for the divided write time periods, and writes data by the magnetic heads in the divided write time periods using a plurality of candidate values of write current, and
wherein the verification step measures error rates of data in the recording area of the target track in which the data is written using a value of the write current, and determines the value of the write current based on results of the error rate measurement.

4. A magnetic storage apparatus comprising:
a plurality of magnetic storage media each including a target track and tracks adjacent to the target track;
a plurality of magnetic heads each corresponding to different one of the plurality of magnetic storage media;
a control unit dividing a target track into a plurality of recording areas on the respective magnetic storage media, assigning each of the plurality of recording areas to each of the plurality of magnetic heads, and writing data by each of the plurality of magnetic heads during one rotation of the magnetic storage media in each of the plurality of recording areas assigned to each of the plurality of magnetic heads; and
a verification unit verifying, after writing data by the magnetic heads, whether data of the tracks adjacent to the target track is held.

5. The magnetic storage apparatus according to claim 4,
wherein the control unit divides a write time needed for each of the magnetic heads to write data in the recording area, sets different values of write current for the divided write time periods, and writes data by the magnetic heads in the divided write time periods using a plurality of candidate values of write current, and
wherein the verification unit verifies whether data of the tracks adjacent to the target track is held, and determines a value of the write current used for writing data in the target track based on results of the verification.

6. The magnetic storage apparatus according to claim 4,
wherein the control unit divides a write time needed for each of the magnetic heads to write data in the recording area, sets different values of write current for the divided write time periods, and writes data by the magnetic heads in the divided write time periods using a plurality of candidate values of write current, and
wherein the verification unit measures error rates of data in the recording area of the target track in which the data is written using a value of the write current, and determines the value of the write current based on results of the error rate measurement.
